(19) United States
(12) Patent Application Publication
(10) Pub. No.: US 2004/0210538 A1
(43) Pub. Date: Oct. 21, 2004

(54) Method of generating or increasing product sales through the dissemination of on-line content for free over a distributed computer network

(76) Inventor: Bruce Forest, Weston, CT (US)

Correspondence Address: OSTROLENK FABER GERB & SOFFEN, 1180 AVENUE OF THE AMERICAS, NEW YORK, NY, 100368403

(21) Appl. No.: 10/826,617

(22) Filed: Apr. 16, 2004

Related U.S. Application Data
(60) Provisional application No. 60/463,176, filed on Apr. 16, 2003.

(51) Int. Cl. G10H 7/00; H04K 1/00; H04L 9/00; G06F 17/60; H04Q 1/00; G10H 1/18

(52) U.S. Cl. 705/80

(57) ABSTRACT

The present invention provides legal dissemination of multimedia content without DRM and without a threat of legal recourse. The present invention provides a system wherein a multimedia digital file is supplied with information (e.g., advertisements), regarding one or more of a consumer goods company's products or services. The multimedia file and accompanying information is disseminated, preferably for free, over a global communications network (e.g., the Internet), and preferably within the file-sharing community.

### CROSS-REFERENCE TO RELATED APPLICATIONS

This application claims priority from, and incorporates by reference the entirety of U.S. Provisional Patent Application No. 60/463,176, entitled METHOD OF GENERATING PRODUCT SALES THROUGH THE DISTRIBUTION OF FREE MUSICAL RECORDINGS, filed on Apr. 16, 2003, and which is currently pending.

### FIELD OF THE INVENTION

The present invention is directed to a method of generating or increasing sales through the distribution of prerecorded multimedia compositions, and, more particularly, to a method for generating or increasing revenue streams for a consumer goods/services company while simultaneously increasing exposure and financial opportunities for musical artists.

### BACKGROUND OF THE INVENTION

In the past, only a few audio recording formats (e.g., 33, 45 and 78 rpm records, 4- and 8-track cartridges) were available. Audio recordings were available for purchase by consumers, for example, in retail stores. Notwithstanding a lack of choices with respect to formats, consumer satisfaction was relatively high, and diverse range of musical artists had an opportunity to enjoy successful and often lucrative music careers.

Over time, the formats of prerecorded music evolved to cassette tapes, compact discs, and, more recently, digital audio tapes and digital mini discs. Further, other prerecorded media formats evolved from broadcast to Betamax, VHS, and DVD. As music formats changed, the companies that produce and/or sell prerecorded music (referred to herein, generally, as “record companies”) worried about the ease at which consumers copy records and compact discs, for example, onto blank cassettes, thereby interfering with the record companies' revenue streams. Despite these worries and the lack of widespread consumer acceptance of the digital audio tape and digital mini disc formats, the music industry continued to thrive until the 1990's.

More recently, many record companies, including large (“major label”) companies, have been acquired by major corporations that may or may not have any prior affiliation with the music industry. Accordingly, unprecedented importance on profitability has been imposed on the record companies resulting in record companies being increasingly risk averse. This has prompted record companies to limit their businesses to very expensive record contracts with well-established musical artists. In order to fund these contracts and maintain profitability, record companies raised the price of prerecorded music. Unfortunately, musical artists who are not well-established often are released from their contracts, signed to very unfavorable recording deals, or simply not offered contracts with any record company. Thus, the diversity of commercially recorded music has declined, particularly in light of the above-identified developments in the record industry.

Similar homogenizing practices have recently occurred in radio and music video television channels which previously were receptive to new and less commercially established musical artists. By the 1990's, many broadcasting companies were bought by large corporations that, predictably, restricted radio and music video content to commercially established sources. As a result, record companies were willing to invest significant promotional funds in very few new acts.

Although consumers and artists have been unhappy with this system, during most of the 1990's they were forced to accept the system as inevitable and unchangeable. Frustrated by rising prices for increasingly generic musical offerings, many consumers began to purchase less prerecorded music. Accordingly, record company profits dwindled or vanished altogether, which contributed to a worsening plight for artists, in general.

By the end of the 1990's, a global communications medium, i.e., the Internet, was burgeoning. Electronic commerce, including the sales of prerecorded music, was routinely being conducted via the Internet. Purchasing music over the Internet has advantages, such as a large selection of music recordings, over traditional brick and mortar retail stores. However, several drawbacks to purchasing prerecorded music over the Internet remain. Most notably, prices are often the same as those offered in traditional brick and mortar retail stores. Also, shipping music to consumers is expensive and delays consumer satisfaction. Accordingly, the number of prerecorded music sales over the Internet has been relatively low.

Meanwhile, new digital formats of music have evolved that make it possible to send or share music between consumers conveniently. Most notably, MPEG-1 audio layer 3 (“MP3”) files employ a digital audio compression algorithm that reduces a digital music file size by a factor of 12, while not adversely affecting sound quality. Previously uncompressed audio formats, for example, WAV files, are now encoded and converted into compressed MP3 files. Commercial and non-commercial (“freeware”) applications have been developed and are available for convenient organization and playback of music files. Thus, users are enabled to download compressed audio files, often in only a matter of seconds, and store the files permanently on their machines.

Recently, file-sharing software (e.g., Napster, Kazaa, Grokster) on the Internet have provided Internet users with technology to share and download multimedia files (e.g., prerecorded music, television programs and films) without paying any money therefor. The technology behind file-sharing has enabled consumers to assemble libraries comprising thousands of multimedia files, often originating from a single file-sharing network. Unfortunately, many users who distribute and receive software and content over file-sharing networks often violate copyright laws, and are subject to civil and criminal liability.

The users of file sharing networks are often computer savvy and often share the belief that the thousands of MP3 and other digital multimedia files on file-sharing networks should be free. This and other shared values, customs, beliefs, language and behavior among files-sharing network users has led to a community of file-sharing users. This is believed to be a natural evolution of Internet developers and users, as witnessed in the growing open source community. In short, users in the open source community share the belief that anyone should be entitled to freely distribute, reverse engineer, modify and copy software, for example, as set forth in the GNU General Public License (GPL). This philosophy extends to the file sharing community.

Even though millions of music consumers flock to file sharing networks to download and/or share multimedia files, it is believed that a relatively small group of file-sharing community users introduce or upload much of the available inventory. Similar to developers in the open source community, users in the file sharing community seek status, for example, by introducing particularly valuable content into the file sharing community. A successful introduction of new and unknown digital content into a large file sharing community can be daunting for a newcomer or relatively inexperienced user. Experienced users in the file-sharing community with clout are more likely to succeed at introducing content into file-sharing networks.

Meanwhile, record companies have been facing unprecedented revenue losses, and, therefore, have sought legal recourse (e.g., injunctions and criminal prosecutions) to stem the tide against perceived illegal file trading. Attempts to shut down file sharing servers have occasionally succeeded. However, for every file sharing network that was successfully shut down, another seemingly sprung up overnight. Recently, record companies have resorted to filing lawsuits against individual file sharers, including minors, which has led to negative press coverage and engendered resentment in the file-sharing community. Legal recourse through the courts has proven long and expensive, and the number of illegally traded multimedia files continues to rise.

Downloading prerecorded music may appear beneficial to consumers, and perhaps indirectly to record companies as well, however, musical artists do not appear to have likewise benefited. If free downloading of prerecorded music continues, record companies will likely become even more selective about the artists they sign, and record contracts will become even more lopsided in favor of record companies. If paid downloading catches on, musical artists will likely be in a similar unfavorable position as they were in the 1990's, since record companies are inclined to promote commercially established artists.

Quite recently and perhaps after facing the realization that music downloading has been embraced by millions of consumers and is likely to be unstoppable, record companies have implemented new business models. For example, users can purchase via one or more services (e.g., BUYMUSIC.COM, ITUNES) digital music files on-line. The purchases may be structured on a per track basis, or a multiple of tracks for a fixed price.

Recently, technological solutions to problems associated with illegal file trading have developed. Most notably, Digital Rights Management (“DRM”), for example as provided by MICROSOFT CORPORATION, provide a series of technological options designed to prevent illegal file trading. Generally, DRM secures digital media files by encrypting digital files, and then associating the files with a code, referred to as a license “key,” which is referenced to decrypt or “unlock” the files. Typically, each license key is associated with a unique machine identifier, such as a computer's MAC address. Ideally, the digital media only plays on the device with the associated machine identifier.

Unlike traditional licenses for music and other media content (for example, audio CD's, videos, and DVD's), DRM typically includes software instructions that can impact the ability for the content to be played. For example, such instructions, when executed, can prevent playback, destroy a digital multimedia file or even cause a computer system to reboot or otherwise perform outside of the control of the operator. Also, variables can be assigned that define when such software instructions should be executed. For example, an expiration date can be defined and used by DRM to prevent playback after that date. Other variables include the act recording to a CD or other digital source; a specific time of day; a number of times a media file has been accessed; a particular machine identifier; and a number of times a media file has been copied. Recent developments in DRM have also provided for encrypting streaming media (i.e., media that is played in real time as it is downloaded over the Internet), for example, from being captured by third party software applications and stored for future use.

Thus, those who offer digital multimedia content for sale typically use DRM. Typically, in accordance with DRM, licenses for multimedia content are centrally managed on a server computer. By centrally managing licenses for many users, distribution of new or upgraded licenses, security fixes, upgrades for version compatibility can be easily implemented. Further, users can purchase multimedia files over the Internet easily and without the need to re-supply registration information. DRM frequently provides for communication between the user's computing device, via the DRM protected content, and the central server computer. Information regarding a consumer's behavior can be easily tracked for future use.

By encrypting multimedia files and defining variables that restrict playback of the multimedia files, record companies attempt to exert control over consumers to ensure compliance with license terms. Users without valid licenses are preferably prompted to obtain a license, for example, via an Internet web site designed to register users. During registration, a user often is prompted to provide personal information, such as name, address, gender, occupation, personal interests and other valuable marketing information. Access to such information is out of the user's control once the registration process is complete. Also, licenses to multimedia content typically cite criminal and civil penalties for noncompliance with the terms. Users in the file-sharing community who seek unencumbered and anonymous on-line activity typically find multimedia licenses and associated registration processes to be undesirable.

Notwithstanding the general acceptance of DRM in the record industry, DRM systems are generally insecure and have been hacked, thereby allowing the multimedia content to be opened and converted to tradable formats (e.g., MP3). Also, multimedia licenses typically contain provisions preventing reverse engineering, a practice revered by the open source community in order to allow devices, such as MS-WINDOWS related devices, to operate in non-WINDOWS environments. Further, opponents to DRM argue that DRM technologies threaten free speech, privacy and fair use. Anonymous activity with respect to multimedia content is believed to be impossible with DRM. Thus, it is believed that record companies are still at odds with the file-sharing community and that prior art technological offerings to protect digital multimedia content are inherently unfair and impractical.

Referring to the drawing figures, in which like reference numerals refer to like elements, there is shown in FIG. 1 a black box diagram generally illustrating a hierarchical arrangement of computing devices and users in a typical file sharing network 100. FIG. 1 illustrates a combination of computing devices and groups of users for distributing multimedia content to and between the file-sharing community 100.

At the top of FIG. 1, a server computer 102, referred to in the art as a “Top Site,” is provided. Top sites are operated by a very small number of users, perhaps fewer than 5,000, who are referred to herein, generally, as part of a super elite user base 102A. Users 102A are considered super elitist because they have extremely restricted access to the top site 102, and they are, in large part, responsible for a significant majority of the content that is distributed in file-sharing communities. For example, a user 102A receives a high quality digital copy of an audio file. The file is stored on the top site, and disseminated to dump sites 104 and private FTP sites 106, which function as storage places for the file to be transmitted, eventually, to many other members of the file-sharing community.

Continuing with the depiction of file sharing community 100 as illustrated in FIG. 1, a third tier of computer servers 108, comprising Internet Relay Chat sites 110, Usenet sites 112, and Public FTP sites 114, provide increased access to digital multimedia files, such as audio and image files, for the file-sharing community. This third tier of servers 108 are much more accessible to the general file sharing community than top site 102, or dump sites 104 or FTP sites 106.

It is believed that at least two general categories of users access the third tier of servers 108 for on-line content. One group, referred to herein, generally, as elite user base 108A is very adept at navigating the third tier of server computers 108 and can access high quality multimedia content quickly. There are believed to be significantly more users belonging to the elite user base 108A than to the super elite user base 102A. A third group of users, referred to, generally, herein as the tech savvy user base 108B comprises approximately 3-5 million users, far more than those of the elite user base 108A. Members of the tech savvy user base 108B use free tools, for example, those that are locatable on public search engines (e.g., GOOGLE), and navigate Internet Relay Chat sites 110, Usenet sites 112, and Public FTP sites 114 in order to identify and download multimedia content.

Continuing with reference to FIG. 1, below the third tier of computer servers 108 is a network commonly referred to as “peer-to-peer network” 116. Generally, any computing device can function on the peer-to-peer network 116 as a source for multimedia content that can be distributed among the file-sharing community. For example, software is installed on a user's computing device that enables the user to identify a particular folder and/or file on the user's hard drive that is available for other members of the community 100 via peer-to-peer network 116. The number of users functioning on the peer-to-peer network 116 are estimated in the hundreds of millions, and comprise Internet download user base 116A.

Notwithstanding the elaborate networking structure and the millions of participants in the file-sharing community 100, much of the downloading and trading activity that takes place therein is illegal. Copyright owners have not waived their rights to restrict users from enjoying multimedia content and, therefore, members of the file-sharing community risk civil and criminal penalties when they take part in file sharing activity.

For decades, record companies (and other copyright owners) have recognized the benefit of using multimedia, for example, songs, to sell goods and services. Most notably, consumer goods companies pay copyright holders to use copyrighted music in commercial advertising. Such advertising is well-known to those skilled in the art and is provided on television, radio and, recently, over the Internet in various contexts. Songs may play in the background of an advertisement, or, alternatively, may be the only audio content in an advertisement. Using music to sell goods and services is believed to be a proven method in the advertising industry.

### SUMMARY OF THE INVENTION

The foregoing illustrates a need in the industry for a system that allows consumers to download multimedia content legally, preferably for free, and in a manner that provides economic and/or creative benefits to musical artists and copyright owners, and to providers who use music to assist in the selling of goods and services.

The present invention addresses the above file-sharing community legal concerns and simultaneously provides a method for delivering prerecorded music to consumers without DRM and without a threat of legal recourse. In lieu of the prior art music industry model wherein record companies sign musical artists to expensive contracts and are involved integrally in the marketing and selling of the artists' prerecorded music, the present invention provides a system wherein a multimedia digital file is supplied with information (e.g., advertisements) regarding one or more of a consumer goods company's products or services. The multimedia file and accompanying information is disseminated, preferably for free, over a global communications network (e.g., the Internet), and preferably within the file-sharing community.

The present invention bridges the gap between millions of users in the file-sharing community who have come to expect multimedia content for free, and the record company industry that seeks to protect revenue generated from music artists.

Although digital files are not protected using DRM, the music and related information are not given away into the public domain. In accordance with an example embodiment of the present invention, the digital files may be freely redistributed by anyone so long as they are redistributed in their entirety, including, for example, the complete audio recording and all associated metadata. Furthermore, preferably the music files are always be distributed with a notice to this effect, which may be included in the metadata of the file or in a separate file.

### BRIEF DESCRIPTION OF THE DRAWINGS

For the purposes of illustrating the invention, there is shown in the drawings a form which is presently preferred, it being understood however, that the invention is not limited to the precise arrangements and instrumentalities shown. The features and advantages of the present invention will become apparent from the following description of the invention that refers to the accompanying drawings, in which:

FIG. 1 illustrates a hierarchical layout representing the file-sharing community;

FIG. 2 is a black box diagram that illustrates a digital package comprising an audio recording and metadata, in accordance with the present invention;

FIG. 3 is an overview diagram of parties and devices associated with the present invention; and

FIG. 4 is a flow diagram illustrating an overview of exemplary methods for making audio files available on a peer-to-peer audio file sharing network in accordance with the present invention.

### DETAILED DESCRIPTION OF THE PREFERRED EMBODIMENTS OF THE INVENTION

The present invention provides a novel way to distribute digital media files in the file-sharing community legally, while simultaneously providing a profitable business model for copyright owners.

As used herein, certain terms are provided with general definitions, which are provided to illustrate common terms in the context of the present invention, and not to replace the normal/customary definitions of these terms.

The terms “artist,” “musical artist,” “musician,” “musical act” and other like terms, as used herein, generally refer to a solo musical performer or to a group of one or more musical performers. A musical artist can be associated with any genre of music now or once known or later defined. A musical artist can also be a non-musical artist (e.g., a poet or a spoken word performer), and is not necessarily required to play a musical instrument.

The terms “consumer,” “customer,” “purchaser,” “user” and other like terms, as used herein, refer generally to a person of any age who has previously purchased or acquired, or is actually or potentially interested in purchasing or acquiring one or more specific consumer products or services for itself, or for another. By way of non-limiting example, both a parent and child would be a “consumer” of a product that would be purchased by the parent but that would be used by the child. Anyone who has previously purchased, downloaded, or is merely familiar with music would be considered a music “consumer.”

The phrase “consumer goods company” and other like phrases, as used herein, pertain to an entity involved in the development, the chain of production, the marketing, and/or the selling of one or more consumer goods, products or services. The term “consumer goods company” is not meant to limit the present invention or example embodiments described herein to consumer goods, and can include, for example, services.

The term “consumer products” refers to any goods, products or services sold by the consumer goods company, which can be any goods/products/services now or once known or later developed, and which are, have been, or will be purchased by a consumer. By way of non-limiting example, consumer goods can include foods and beverages, or services, such as income tax form preparation. It is also understood that the consumer product(s) can be produced by the consumer goods company itself, by a related entity (e.g., an affiliate, a subsidiary, a partner company), or through a joint effort between the consumer goods company and another company.

As used herein, the terms, “multimedia digital files,” “multimedia files” and “multimedia” refer, generally, to digital files containing content that includes audio, television programs, film, video video-game and software applications. Such content may be previously unavailable in any medium, may be previously available in non-digital format, or may be previously available in digital form. The format of digital multimedia files in accordance with preferred embodiments of the present invention may be any known format, including, for example, mp3 (mpeg audio), wav (wav audio), mpg, mpeg, mpv (mpeg video), mps, m2v, m/v, mpe (mpeg media), mpa (mpeg media), avi (avi video), mp4, m4e (mpeg-4 video/audio), ra, rm, ram, rv (realaudio audio/video), wma (windows media audio file, no DRM), wmv (windows media video file, no DRM), asx, asf (windows media audio file), wm (windows media audio/video file), qt (quicktime audio/video), aac, m4a (apple aac audio, no DRM), acp (apple aac for sd, no DRM), mp2 (mp2 audio), mp1 (mp1 audio), mpga (mpeg audio), smi, smil (smil multimedia presentation), au (sun au audio), aif, aiff, aifc (aiff audio, with or without compression), 3gp (3gpp content), amr (amr narrow-band content), awb (amr wide-band content), 3g2 (3gpp2 content), snd (NeXT sound file), iff, 8svx (amiga sound file), sf (IRCAM sound file), smp (Turtle Beach sound file), voc (Soundblaster sound file), wve (Psion sound file), hcom (headerless Mac sound file), and mod, nst (Amiga),

Also, accessing or downloading prerecorded musical compositions from a global communication network may be described herein as being “free of charge” or “free” which does not mean to imply that it is likewise “free” to access or utilize a global communication network in furtherance of the free accessing/downloading process. By way of non-limiting example, some charges and/or fees (e.g., to an Internet Service Provider, to a so-called “Internet Café”) may be required in order to access/utilize a global communication network in connection with the present invention.

As used herein, “Digital Rights Management” or “DRM” is referred to, generally, as any software, device, or technical means of preventing the unrestricted distribution and/or playback of the audio, video, or other data stored in a file in a computer or other digital reproduction device. Some forms of DRM allow the extraction of the audio, for example, but only at reduced fidelity. By way of non-limiting example, Apple Computers' AAC files can be played on up to three Apple-approved devices, and allows burning onto a non-protected CD only at a reduced fidelity.

Also as used herein, the term “metadata” refers generally to any information or other data included in the file along with the audio. By way of non-limiting example, MP3 files generally contain the artist's name, the name of the song, and the genre of the music. In accordance with an example embodiment of the present invention, metadata includes advertising information regarding at least one good or service that is coupled with multimedia content and provided in a digital format.

Furthermore, although many of the examples described herein describe musical compositions, the invention is not so limited. Any digital object that contains multimedia (sound, video, still image, or the like) content is envisioned by the present invention.

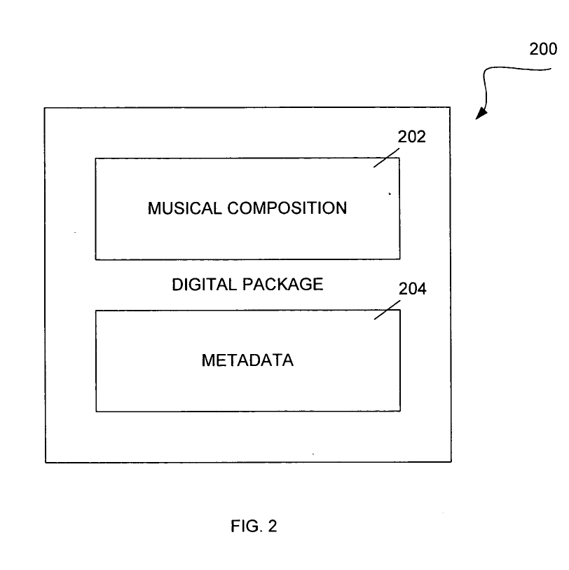

FIG. 2 is a black box diagram that illustrates a digital package 200 of the present invention. As shown in FIG. 2, multimedia content (e.g., musical composition 202) is encoded (referred in the industry as “ripped”) and coupled with metadata 204 to form digital package 200.

According to an example embodiment of the present invention, a consumer goods company selects one or more musical artists who has rights to one or more musical compositions 202. These can be any musical artists, from the unknown to the internationally famous. The consumer goods company preferably enters into a relationship (e.g., a contractual relationship) with the artist(s) that allows the consumer goods company to disseminate music performed and/or composed by the musical artist(s) in accordance with the teachings described herein.

Either prior to or following the consumer goods company's selection of the musical artist(s), a sales and/or marketing campaign may be developed in which the musical artist and/or the musical composition 202 is introduced to the public and associated with the one or more consumer goods and/or services.

After the artist is selected, it preferably provides the consumer goods company with access to one or more of its musical compositions 202. This may mean that the artist records a new musical composition 202, performs an existing musical composition 202, or provides the consumer goods company with a previously recorded musical composition 202. The consumer goods company may purchase outright the copyright to any musical composition 202, or, alternatively, may enter into a contractual agreement with the artist that provides more limited rights to the composition.

In one embodiment of the present invention, the music composition supplied by the artist is associated (referred to herein, generally as “branded”) with a marketing plan developed by the company. The branding may include various components associated with the metadata in digital package 200. By way of non-limiting example, the branding may be a brief mention of the product at the end of the song, a pop-up window that shows the product logo when the music is played on a computer, or text in a display on a portable playing device, such as a portable MP3 player.

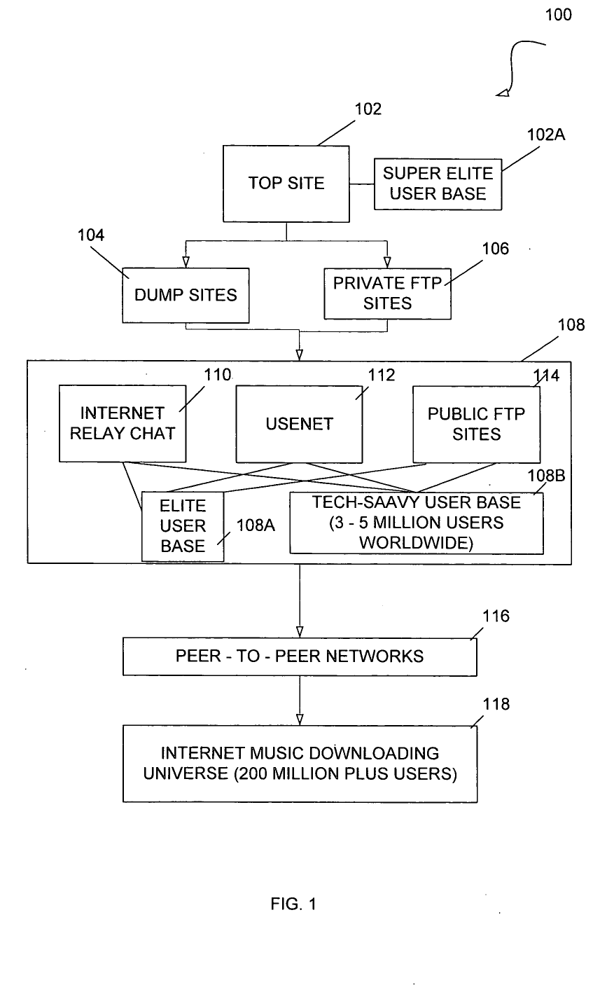

After musical composition 202 and metadata 204 are coupled, package 200 is then disseminated over a global communication network (e.g. the Internet) in one or more predetermined manners such that the recordings can be heard and/or downloaded. In a preferred embodiment of the present invention, digital package 200 is released into the file-sharing community to a dump site 104, private FTP site 106 or even top site 102 (FIG. 1). Of course, one skilled in the art will recognize that any manner of distributing digital package 200 into the file-sharing community is envisioned, and will further recognize the potential difficulty associated with distributing multimedia content in the upper tiers of server computers as shown in FIG. 1. More particularly, one who attempts to disseminate digital package 200 into the file-sharing community may work within the third tier of computer servers 108, comprising Internet Relay Chat sites 110, Usenet sites 112, and Public FTP sites 114, in order to identify specific users who carry clout in the community and may assist with the distribution of package 200. In any event and in accordance with an example embodiment of the present invention, digital package 200 is accessible (e.g., downloadable) for free via a global communication network and without the intrusions typically imposed by DRM.

Digital package 200 may also be accessible on an Internet web page that is otherwise not part of the file-sharing community. For example, package 200 may be available on a Internet web page pertaining to the consumer good company, pertaining to a product to which the recordings are branded, and/or pertaining to the musical artist.

In accordance with the present invention, financial compensation will be realized by the parties. The musical artist(s) receives compensation for musical composition 202, wherein the compensation may be based on various criteria. For example, the musical artist receives compensation based upon the achievement or realization of certain predetermined milestones, such as the number of units of products/services associated with musical composition 202 that are sold. Alternatively, the artist may be compensated based on the number of separate instances that its music is accessed (e.g., downloaded) from a distributing web site. In this way, the free downloading of music from the Internet actually contributes to a revenue stream according to the business model of the present invention.

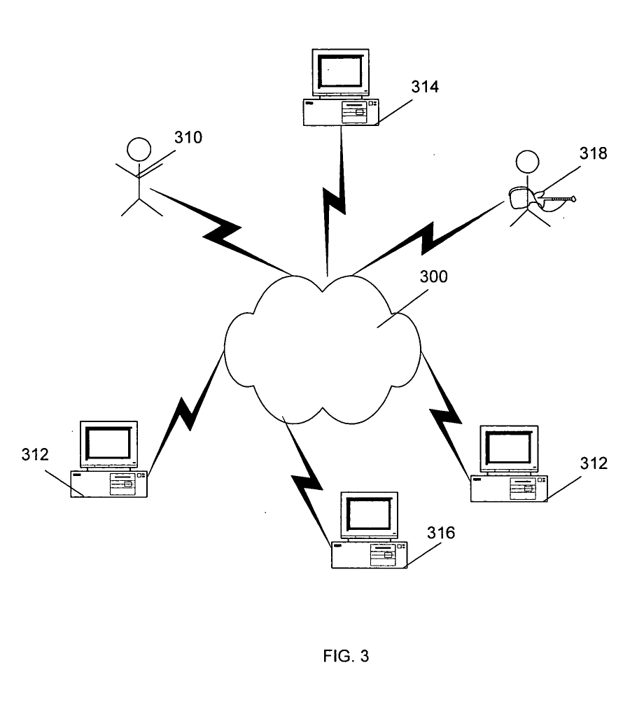

FIG. 3 illustrates parties and computing devices that interact via a global communication network in accordance with the present invention. As shown, various users 310 connect via computers or other suitable devices 312 in order to access package 200 that is preferably stored on one or more servers 314. Also, consumer goods company 316 interacts with musical artist 318 which together contribute to the formulation of digital package 200. Other variations of FIG. 2 are well known in the art, and are intended to be encompassed by the present invention.

Generally, and as shown in FIG. 2, each server 314 communicates with the global communication network 300 via a separate communication channel, as is generally known in the art. Each server 314 hosts predetermined content and computer network resources (e.g., web sites, databases, etc.) and distributes memory and processing as is well known.

The global communication network 300 may include any number of networked systems now known or hereinafter developed. For example, global communication network 300 may be one of or a combination of local area networks (LAN), wide area networks (WAN), intranets or the global communications medium commonly referred to as “the Internet,” each of which is well known. In a currently preferred embodiment of the present invention, the global communication network 300 is the Internet.

A plurality of users 310 can utilize one or more computers or other suitable devices (e.g., portable, wearable and/or handheld devices) 312 to access information on the servers 314 via the global communication network 300, with which the computers communicate via wired or wireless communication channels. The systems, devices and techniques that enable the devices 312 to access the global communication network 300 are well known to those of ordinary skill in the art.

Referring once again to a branding campaign that may be associated with the present invention, many factors, including the goals and resources of consumer goods company 316, as well as the type of and market for the consumer product(s) may impact a branding campaign. By way of non-limiting example, the branding campaign can include developing, renaming, and/or reformulating a product or product line that would benefit from being associated with one or more musical artists 318, as well as developing a sales and/or marketing campaign directed to that product or line. Musical artist 318 can, but generally will not have significant involvement in the development, shaping and implementation of a branding campaign.

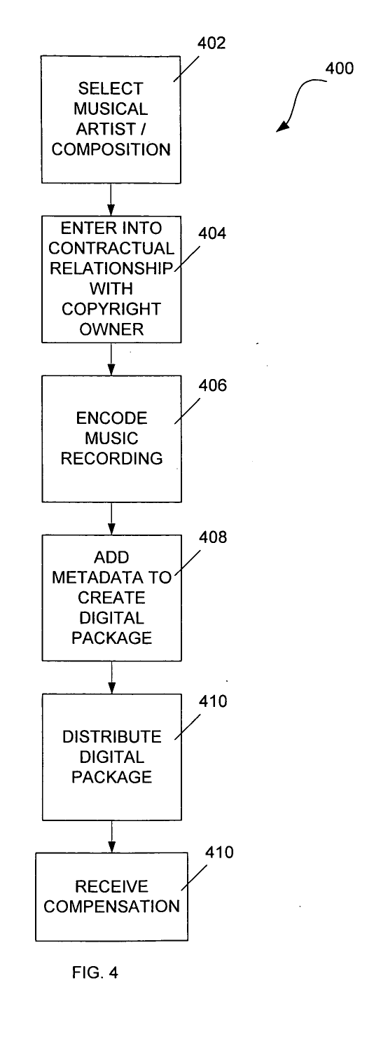

FIG. 4 is a flow chart that illustrates steps associated with a business method 400 that replaces the prior art methods for disseminating prerecorded music. The various steps 402-412 of the process 400 represent steps in an example embodiment of the present invention that pertains to consumer goods company 316. In the example embodiment described with reference to FIG. 4, consumer goods company 316 enters into a contractual relationship with artist 318 or other copyright owner of musical recordings.

At step 402, consumer goods company 316 selects a musical artist 318 and/or a musical composition 202 that consumer goods company 316 desires for advertising purposes. The selection process may vary depending on criteria, such as whether consumer goods company 316 is comfortable with artist 318 being associated with the company, and wherein such an association would comport with the company's goals and/or viewpoints. Exemplary selection criteria could pertain the artist's 318 music (e.g., its genre, the number of previous releases of musical artist 318, the sales figures for such release(s)) and/or to non-musical factors (e.g., the artist's age(s), its past, present or anticipated demographic, the lyrical content of its music, and even its moral beliefs and/or political platform).

According to an example embodiment of the present invention, either consumer goods company 316 or musical artist 318 owns the right to record the composition(s). For example, the artist may have written (and owns) the composition(s). Alternatively, the composition(s) may have been written by an unrelated entity, but either musical artist 318 or consumer goods company 316 has the right to record and disseminate copies of the composition(s).

During step 404, a contractual relationship is preferably entered into between the artist (and/or the copyright owner) and consumer goods company 316. The contractual relationship preferably binds the parties to contribute to the creation of digital package 200 and to its dissemination, for example, in the file-sharing community. At step 406, musical artist 318 provides consumer goods company 316 with access to one or more of the artist's musical compositions 202 and the composition is encoded, for example, to MP3 format.

At step 408, the encoded musical composition 202 is coupled with metadata 204 to create digital package 200. Preferably, metadata 204 includes an advertisement representing a good or service provided by consumer goods company 316. At step 410, digital package 200 is disseminated on-line, for example, in the file-sharing community or any other Internet-related resource. After digital package 200 is downloaded and enjoyed, the music consumer purchases the goods or services described in the metadata and financial compensation to consumer goods company 316 and/or musical artist 318 is realized.

The consumer good(s)/product(s)/service(s) that are associated with digital package 200 may fall within any category of goods or products now or previously known or later developed. According to a currently preferred embodiment of the present invention, the consumer good/product is a food or a beverage.

The business model of the present invention enjoys several important advantages over the traditional system for disseminating prerecorded musical compositions. Many of these advantages stem from an embracing of downloading digital prerecorded music, and that benefits consumers, musical artists 318 and consumer goods companies 316 alike.

Consumers are benefited in that they will be permitted to—and, in fact, will be encouraged to—partake in an activity they enjoy, namely accessing (e.g., downloading and sharing) music for free via the Internet. Plus, they will have increased access to the music they already enjoy, and will be able to discover new music, which, under the current system, is largely being ignored by radio and music video channels.

Musical artists 318 will be unshackled from the previous necessity of entering into unfavorable relationships with record companies, and will enjoy an unprecedented ability to earn income while still being able to deliver their music to both their existing fan base and to the hundreds of millions of potential new fans that access prerecorded music via the Internet.

Consumer goods company 316 will be directly benefited by increased sales of product(s) and service(s), and also indirectly benefited by goodwill gained due to the public's knowledge that the company has enabled consumers to engage in permissible and free downloading of prerecorded music. These indirect benefits could be sizeable, since there will likely be enormous press coverage and a tremendous “buzz” and word-of-mouth surrounding the launch of new releases. Moreover, the company's 316 name and/or its product(s) will likely be mentioned or associated with most, if not all of this coverage. This will likely lead to increased sales of the branded products, and, indirectly, to other company products as well.

The present invention is now further described by way of a specific example.

Consumer goods company 316 manufactures and sells beverages—including various juices as well as flavored and unflavored iced tea products—and is seeking to contract with musical artist 318 either to a currently available, a formerly available or a not-yet-for-sale mango-flavored iced tea product.

Consumer goods company 316 screens musical artists in order to identify one or more that are compatible with the company's needs. Consumer goods company 316 can utilize the assistance of a related or unrelated entity to suggest potential musical artists and/or to actually screen the artists. Once a suitable pool of musical artists has been screened and a predetermined number of candidate artists have been identified, one or more candidate artists 318 are selected.

In this instance, the criteria can include, e.g., factors that would predict the likelihood of the artist's new or existing fan base buying the mango-flavored iced tea product to which the artist is branded. Preferably, but not necessarily, there should be at least some overlap between the demographic of the musical artist and the target audience for the branded mango-flavored iced tea product.

Another criteria could be whether (and, if so, to what extent) the name of the musical artist can be tied to or modified to be tied the name of the branded mango-flavored iced tea product. For example, consumer goods company 316 might favorably consider artists 316 whose names include, suggest or rhyme with the word mango, or artists whose reputations connote an image the company believes could be beneficially branded to the mango-flavored iced tea product.

In accordance with this example, and during the screening portion of the process, consumer goods company 316 becomes aware of an unaffiliated musical artist named (or willing to change its name to) “Mango Chaos.” It should be noted that this is intended to be a hypothetical band name.

Once Mango Chaos and any other unaffiliated musical artists that meet the predetermined criteria have been selected, the artists are approached by consumer goods company 316 directly, or by one or more authorized representatives of the company in order to explore whether the selected musical artist(s) are interested in and eligible to enter into an association with the company.

Assuming that there is mutual interest on the part of Mango Chaos, consumer goods company 316 enters into a relationship with Mango Chaos, as described above, wherein Mango Chaos agrees to provide the consumer goods company with one or more of its prerecorded musical compositions in exchange for compensation.

By way of non-limiting example, consumer goods company 316 may enter into a contractual relationship with Mango Chaos that guarantees the member(s) of Mango Chaos a total or per member salary (e.g., $10,000 per year) and that further enables the member(s) of Mango Chaos to be compensated (e.g., at a rate of $1.00 per 100 units sold) based on future sales of the mango-flavored iced tea product to which Mango Chaos and/or its music are branded.

It is understood that the rate of future compensation for the member(s) of Mango Chaos could be influenced (i.e., could differ) depending on whether the branded mango-flavored iced tea product is being initially launched, or whether, instead, the branded mango-flavored iced tea product has previously been made available for sale and is being renamed and/or reformulated.

At this or at an earlier or later stage, a branding campaign is launched. The goal of the branding campaign is to develop marketing strategies and approaches that are designed to brand “Mango Chaos” and its recordings to the mango-flavored iced tea product manufactured by consumer goods company 316. Generally, but not necessarily, this will entail naming or renaming the branded mango-flavored iced tea product to suggest or connote an affiliation with the musical artist “Mango Chaos” and/or its musical compositions.

Once one or more recorded musical compositions performed by Mango Chaos are secured by consumer goods company 316, the musical compositions are disseminated—at predetermined/strategic times (e.g., to coincide with the launch or relaunch of the branded product)—to consumers via web pages and/or so-called peer-to-peer audio file-sharing networks and communities as described above.

In accordance with the present invention, Mango Chaos is compensated, as described above, thus providing Mango Chaos with a realistic opportunity to make a living without dealing with record companies, while also providing consumer goods company 316 with the opportunity for significant sales of its mango-flavored iced tea product due to the branding of the product with Mango Chaos and its musical compositions.

Other promotional opportunities—beyond those described above—exist based on the relationship between Mango Chaos and consumer goods company 316. For example, labels of the branded mango-flavored idea tea product could bear a numeric, alphabetic or alpha-numeric code, which could be presented (e.g., entered on a web page, presented in person at a retail location, mailed to a predetermined address) to bestow a certain amount of credit upon a purchaser of the branded product.

Enough amassed credit could entitle one to premiums or special privileges relating to the Mango Chaos, such as free or discounted merchandise (e.g., CD's, DVD's), free, discounted or upgraded tickets to live performances, access to content (e.g., access to special web pages, web-casts, and/or “streaming” content, etc.), or chances to interact with Mango Chaos (e.g., to meet Mango Chaos, to receive Mango Chaos memorabilia and/or autographed items, to receive a phone message or greeting from Mango Chaos). Additionally or alternatively, amassed credit could entitle one to savings and/or free offers pertaining to the branded mango-flavored iced tea product or to other products manufactured by consumer goods company 316 or a partner company.

The present invention also readily provides the consumer goods company (and/or partner companies) with other revenue opportunities in addition to revenue derived from sales of the branded mango-flavored iced tea product. These opportunities can be utilized for further profit or to offset expenses incurred by consumer goods company 316 in connection with the above.

Exemplary revenue opportunities include, but are not limited to, arranging for co-sponsorships (e.g., of tours and live performances of Mango Chaos) and selling or entering into agreements to sell Mango Chaos merchandise and apparel (e.g., at live performances, at retail outlets, on web pages).

Moreover, consumer good company 316 could gain additional revenue by licensing the musical recordings of Mango Chaos. For example, Mango Chaos' musical recordings can be licensed to other artists to rerecord or to sample in their own recordings, and/or licensed for use in connection with advertisements for non-competing products. Also, the image or likenesses of the member(s) of Mango Chaos can be licensed, e.g., to merchandisers for use on products.

Consumer goods company 316 could also be benefited by other revenue opportunities involving musical artist 318, including, but not limited to merchandising (e.g., CDs, DVDs, apparel), touring, and so-called “web-casts” and “streaming.” Consumers will be introduced to new music artists 318 and musical compositions 202 via streaming, thereby creating new revenue opportunities. It is believed that these revenue opportunities will more than compensate for the time and money that consumer goods company 316 invests in musical artist 318, and thus will not necessitate the company charging fees for the artist's music, as was required according to the prior art system of disseminating multimedia content via DRM.

Although the present invention has been described with reference to a commercial company 318, other parties may take advantage of the present invention. For example, a political party or politician may use the present invention to provide political messages in metadata 204.

Thus, the present invention provides solutions to prior art on-line multimedia distribution. Digital package 200 preferably contains an entire and uninterrupted version of a song or other content. Further, digital package can be distributed anonymously, without a threat of civil or criminal liability subjected on the consumer.

Unlike prior art on-line dissemination methods, the present invention increases the likelihood that diverse forms of multimedia will be distributed, as opposed to prior art generic forms that currently being distributed. Also, the present invention removes a threat to free speech, privacy, fair use or other civil liberties that are believed to be implicit in DRM techniques. Furthermore, the present invention is developed with the file-sharing community in mind, and will be perceived by millions in the file-sharing community as fair and valuable.

It is preferred that the present invention not be limited by the specific disclosure herein.

What is claimed is:

1. A method for making multimedia content available to consumers, the method comprising:
accessing the multimedia content;
encoding the multimedia content in a format for distribution;
providing a package comprising the encoded multimedia content and metadata;
electronically distributing the package;
permitting the consumers to copy the electronically distributed package to a copied package; and
permitting the consumers to distribute the copied package.

2. The method of claim 1, wherein the multimedia content is at least one of a song, audio recording, television programs recording, film, video video-game and software application.

3. The method of claim 1, wherein the format is at least one of: mp3, wav, mpg, mpeg, mpv, mps, m2v, m/v, mpe, mpa, avi, mp4, m4e, ra, rm, ram, rv, wma, wmv, asx, asf, wm, qt, aac, m4a, acp, mp2, mp1, mpga, smi, smil, au, aif, aiff, aifc, 3gp, amr, awb, 3g2, snd, iff, 8svx, sf, smp, voc, wve, hcom, mod and nst.

4. The method of claim 1, wherein the step of distributing the package further comprises uploading the package to at least one of a top site, FTP site, Usenet site or Internet Relay Chat site.

5. The method of claim 1, wherein the step of distributing the package further comprises uploading the package to at least one of an Internet web site pertaining to a consumer goods company, a particular good or service, and a musical artist.

6. The method of claim 1, wherein the metadata does not comprise Digital Rights Management.

7. The method of claim 1, wherein the metadata comprises an advertisement.

8. The method of claim 7, further comprising providing the metadata while the multimedia content is playing.

9. The method of claim 8, wherein the metadata is provided in at least one of a text display device, a video graphic display device, and an audio device.

10. A method for generating revenue for an artist, the method comprising:
making an audio recording;
providing the rights to the audio recording to a consumer goods company;
encoding the audio recording to a distributable format;
adding metadata to the audio recording to create a package, wherein the metadata comprises an advertisement for at least one of a good and service;
electronically distributing the package and enabling anyone to copy and redistribute the package;
determining when the package is copied; and
providing compensation to the artist each time the package is copied.

11. The method of claim 9, further comprising receiving compensation from the consumer goods company each time the at least one of a good and service is purchased.

12. The method of claim 9, wherein the distributable format is MP3.

13. The method of claim 9, wherein the step of distributing the package further comprises uploading the package to at least one of a FTP site, Usenet site or Internet Relay Chat site.

14. The method of claim 9, wherein the step of distributing the package further comprises uploading the package to at least one of an Internet web site pertaining to a consumer goods company, a particular good or service, and a musical artist.

15. The method of claim 9, wherein the metadata does not comprise Digital Rights Management.

16. The method of claim 9, wherein the metadata comprises an advertisement.

17. The method of claim 15, further comprising providing the advertisement while the audio recording is playing.

18. A method for generating revenue for a consumer company, the method comprising:
a) screening a pool of musical artists;
b) selecting at least one musical artist from the pool of musical artists based upon predetermined criteria;
c) branding a consumer good to selected musical artist; and
d) receiving revenue from a sale of the consumer good.

19. The method of claim 18, further comprising the step of: disseminating at least one prerecorded musical composition performed by the musical artist such that the prerecorded musical composition is accessible via a distributed computer network.

20. A system for making multimedia content available to consumers, the system comprising:
a memory that accesses the multimedia content, and that provides metadata;
an encoder that encodes the multimedia content to a format for distribution;
a combining module that provides a package comprising the encoded multimedia content and the metadata;
a communication network for electronically distributing the package; and
a license agreement that permits the consumers to copy the electronically distributed package to a copied package and that permits the consumers to distribute the copied package.

21. The system of claim 20, wherein the package does not contain any digital rights management.
